(19) United States
(12) Patent Application Publication
(10) Pub. No.: US 2007/0255869 A1
(43) Pub. Date: Nov. 1, 2007

(54) Device evaluation using automatic connection path reconfiguration

(75) Inventors: Brandon M. Walters, Newcastle, WA (US); Daniel Studley, Redmond, WA (US); Firdosh K. Bhesania, Kirkland, WA (US); Iain R. Campbell-Smith, Redmond, WA (US); Mark E. Maszak, Sammamish, WA (US)

Correspondence Address: WOLF GREENFIELD (Microsoft Corporation);C/O WOLF, GREENFIELD & SACKS, P.C., 600 ATLANTIC AVENUE, BOSTON, MA, 02210-2206, US

(73) Assignee: Microsoft Corporation, Redmond, WA (US)

(21) Appl. No.: 11/413,496

(22) Filed: Apr. 27, 2006

(51) Int. Cl. G06F 13/38

(52) U.S. Cl. 710/62

(57) ABSTRACT

Testing of computing devices and/or peripherals coupled via a wired bus may be facilitated through automatically re-configuring connections between computing devices and peripherals. A switching device may selectively couple and de-couple computing devices and peripherals for testing purposes. A control device may send control commands to the switching device to couple and decouple computing devices and peripherals in accordance with a testing schedule or program. The ability of a peripheral device and a computing device to function together while coupled via the wired bus may be evaluated.

### BACKGROUND

Some peripheral devices, such as a mouse or keyboard, can be connected to a computer via a wired connection, e.g., a universal serial bus (USB) connection. To ensure that a computing device will function appropriately with a peripheral, the computing device and the peripheral are subjected to testing, e.g., by a manufacturer or developer of the computing device or the peripheral device. Adequately testing a device and peripheral can prevent costly support calls and customer dissatisfaction. To ensure that the devices will function appropriately under a variety of anticipated usage conditions, it may be necessary to test a number of different scenarios.

As one example, the computing device and peripheral may be tested to ensure that they function appropriately when the peripheral is connected or disconnected from the computing device. To test such a scenario, a person may manually plug the peripheral device into the computing device and manually unplug the peripheral device from the computing device. The ability of the computing device to recognize and function appropriately with the peripheral device in response to the plugging/unplugging may be observed.

As another example, a computing device may be tested to ensure that it functions appropriately with several different peripheral devices. To test such a scenario, a person may manually plug a first peripheral device into the computing device. The computing device may be tested with the first peripheral device, and the person may manually unplug the first peripheral device. Next, the person may manually plug in a second peripheral device, and the computing device may be tested with the second peripheral device. Several peripheral devices may be manually plugged/unplugged and tested with the computing device.

### SUMMARY

The Applicants have appreciated that it may be desirable to automatically re-configure connection paths to facilitate testing of computing devices with peripheral devices. In accordance with the invention, one or more peripheral devices can be connected to a computing device via a configurable switching device that enables automatically re-configuring connections between one or more computing devices and one or more peripheral devices. Automatic re-configuring of connection paths may eliminate the need for manually plugging/unplugging devices during testing. For example, the switching device may selectively connect and disconnect connections between the computing device and the peripheral devices. The switching device may be configurable via software, firmware, or a combination thereof, enabling controlling the timing of connecting/disconnecting a connection.

The switching device may enable selectively connecting one or more peripheral devices to a computing device coupled to the switching device. Using software and/or firmware to re-configure the switching device, several different peripheral devices may be tested with the computing device simultaneously and/or in sequence. For example, a first peripheral may be connected to the computing device, the computing device may be tested, and then the first peripheral may be disconnected. After the first peripheral has been disconnected, a second peripheral device may be connected, and the computing device may be tested with the second device. The connecting and disconnecting of the peripherals may be performed through automatic re-configuration of the switching device, without the need for manually plugging or unplugging of connections during the test. As one example, the switching device may be controlled by a control device that is programmed to connect and disconnect connections at various times in accordance with a testing schedule.

The switching device may enable connecting a peripheral device to one or more computing devices. For example, a peripheral device may be tested to ensure that it functions appropriately with a variety of different types of computers or other types of computing devices.

One embodiment of the invention relates to a method of evaluating a computing device. The computing device is coupled to a switching device. The switching device is coupled to a first peripheral device and a second peripheral device. The method includes configuring the switching device to couple the first peripheral device to the computing device via the switching device. The method also includes evaluating a response of the computing device to coupling the first peripheral device to the computing device. The method also includes automatically re-configuring the switching device to couple the second peripheral device to the computing device via the switching device. The method further includes evaluating a response of the computing device to coupling the second peripheral device to the computing device.

Another embodiment of the invention relates to a computer-readable medium having computer-executable instructions encoded thereon that, when executed, perform acts of a method of evaluating a computing device. The computing device is coupled to a switching device. The switching device is coupled to a first peripheral device and a second peripheral device. The method includes configuring the switching device to couple the first peripheral device to the computing device via the switching device. The method also includes evaluating a response of the computing device to coupling the first peripheral device to the computing device. The method also includes automatically re-configuring the switching device to couple the second peripheral device to the computing device via the switching device. The switching device is automatically re-configured in response to receiving a test command. The method further includes evaluating a response of the computing device to coupling the second peripheral device to the computing device.

A further embodiment of the invention relates to a system for evaluating at least one peripheral device. The system includes a computing device coupled to a switching device. The switching device is coupled to a first peripheral device and a second peripheral device. The system is configured to couple the first peripheral device to the computing device via the switching device. The system is also configured to evaluate a response of the first peripheral device to coupling the first peripheral device to the computing device. The system is also configured to automatically re-configure the switching device to couple the second peripheral device to the computing device via the switching device. The system is further configured to evaluate a response of the second peripheral device to coupling the second peripheral device to the computing device.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a diagram illustrating an example of a computing environment in which embodiments of the invention may be implemented, including examples of a computing device and two peripheral devices;

FIG. 2 is a flowchart illustrating an example of a method of evaluating a computing and/or a peripheral device, according to some embodiments of the invention;

FIG. 3 is a diagram illustrating an example of a computing environment in which embodiments of the invention may be implemented, including examples of two computing devices and one peripheral device;

FIG. 4 is a diagram illustrating an example of a computing environment in which embodiments of the invention may be implemented, including examples of multiple computing devices and multiple peripheral devices; and

FIG. 5 is a block diagram showing an illustrative implementation of a computing system in accordance with some embodiments of the invention.

### DETAILED DESCRIPTION

The Applicants have appreciated that prior methods of testing the ability of a computing device and peripheral device to function together may be time consuming and cumbersome due to the need for a lot of human interaction during a test, e.g., manually plugging and unplugging peripheral devices. Manually plugging and unplugging of peripheral devices may be particularly cumbersome if there are a large number of different peripheral devices, computing devices and/or device configurations that need to be tested. As one example, a computing device may need to be tested with multiple different types of peripheral devices. As another example, a peripheral device may need to be tested with multiple different types of computing devices. Testing a large number of computing devices, peripherals and/or device configurations may require a large test matrix, which may be cumbersome and time consuming if devices need to be plugged and unplugged manually. Furthermore, excessive physically cycling by manually plugging and unplugging a connection may cause damage to a connector, thereby causing a testing delay.

In accordance with the invention, a configurable switching device is provided that enables automatically testing a computing device with multiple peripheral devices. The configurable switching device may be automatically re-configured to change which peripheral is connected to the computing device. Embodiments of the invention may enable testing a large number of different peripheral devices, computing devices and/or device configurations without a lot of human interaction or manually plugging/unplugging devices during the test.

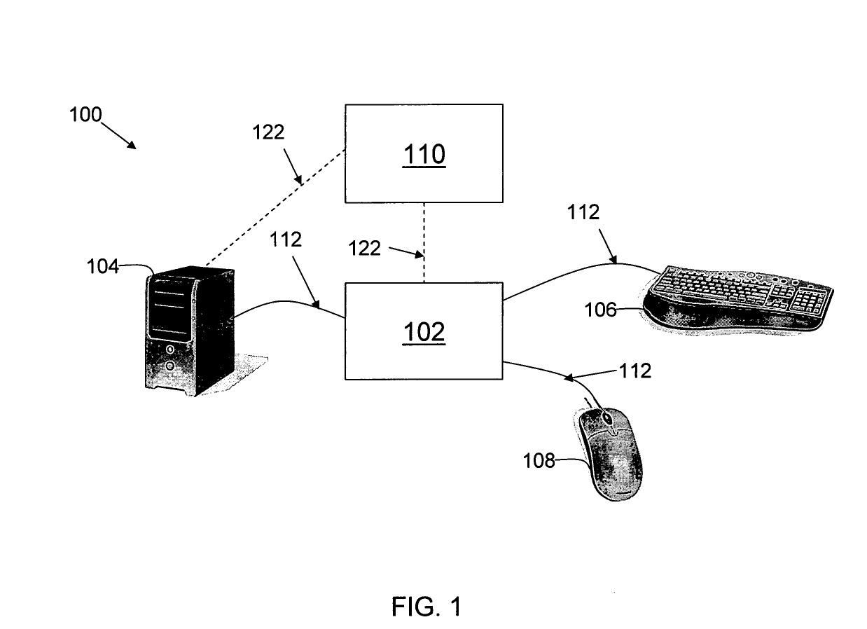

FIG. 1 is a diagram illustrating an example of a computing environment 100 in which embodiments of the invention may be implemented. FIG. 1 illustrates an example of a switching device 102, a computing device 104, a keyboard 106, a mouse 108, a control device 110 and a wired bus 112. Computing device 104, control device 110 and switching device 102 may be coupled via control connections 122.

Computing device 104 may any suitable device capable of communicating with a peripheral device. Computing device 104 may be, for example, a computer, a server, a television, a video game console or any other suitable device, as the invention is not limited in this respect.

Computing device 104 may be coupled to one or more peripherals, such as keyboard 106 and mouse 108, via switching device 102. Keyboard 106 and mouse 108 have been illustrated in FIG. 1 as examples of peripherals to which computing device 104 is coupled. However, any suitable type of peripheral may be coupled to computing device 104 through switching device 102, such as a printer, scanner, digital camera, hub, flash drive or other storage device, personal digital assistant (PDA), and portable audio player, e.g., MP3 player. The invention is not limited as to the type or number of devices that may be coupled to computing device 104.

Wired bus 112 may be any wired bus suitable for communications between computing device 104 and a peripheral device, such as a USB, FireWire (IEEE Standard 1394), Ethernet, Personal Computer Memory Card International Association (PCMIA), Secure Digital Input/Output (SDIO) or Serial Advanced Technology Attachment (SATA) bus. In some embodiments wired bus 112 may be a hot-pluggable bus, for example, capable of supporting plug-and-play operation. However, any suitable type of wired bus may be used, as the invention is not limited in this respect.

Switching device 102 may be coupled to computing device 104, keyboard 106 and mouse 108 via a wired bus 112. Switching device 102 may selectively connect and disconnect a peripheral device to computing device 102. Switching device 102 may include switches which may connect and/or disconnect one or more conductive lines of wired bus 112. Switching device 102 may include any suitable type and number of switches. Switching device 102 may connect and disconnect connections in response to commands from control device 110.

Control device 110 may be a server or any other suitable type of computing device capable of sending control commands to switching device 102. Control device 110 may be a programmable device capable of executing computer-readable instructions for performing a test of computing and peripheral devices. Control device 110 may send commands to switching device 102 to control turning on and off switches in switching device 102, thereby connecting and disconnecting computing device 104 to one or more peripherals. The control commands may be sent from control device 110 to switching device 102 in any suitable way, such as over a wireless connection or wired connection, e.g., USB connection. However, device 110 need not necessarily be a separate device from switching device 102, as both control device 110 and switching device 102 could be implemented in the same device, as the invention is not limited in this respect.

Control connections 122 may be any suitable connections, such as wired or wireless connections. The control connection 122 between computing device 104 and control device 110 may be the same type of control connection as the control connection 122 between control device 110 and switching device 102, or the two control connections may be different. For example, the control connection 122 between computing device 104 and control device 110 may be an Ethernet connection, and the control connection 122 between control device 110 and switching device 102 may be a USB connection. In some embodiments, a control connection 122 need not be present between computing device 104 and control device 110. For example, computing device 104 could be a dumb terminal, and the execution of the test cases could be controlled by control device 110.

Aspects of the invention can be implemented by software running on a computing device, e.g., computing device 104, and/or by software running on control device 110. Software running on computing device 104 may control running a test case for various configurations of peripherals to be tested with computing device 104. One example of a test scenario is a manufacturer of computing device 104, who wishes to ensure that computing device 104 will function appropriately using various numbers of peripheral devices, types of peripheral devices, and combinations of peripheral devices. Computing device 104 may have a large list of test scenarios that need to be tested. For example, a first test may include determining the response of computing device 104 when mouse 108 is connected to it. A second test may include determining the response of computing device 104 when keyboard 106 is connected to it. A third test may include testing with both mouse 108 and keyboard 106 connected to computing device 104. Further tests may include evaluating the peripheral devices when they are connected to computing device 104 via one or more hubs, testing for different types of keyboards and mice, testing of keyboards and mice when other devices are connected to computing device 104, etc. A large variety of tests may be run with peripherals arranged in different combinations of “device trees,” e.g., different connection path topologies.

Test software running on computing device 104 may be programmed with the various test configurations to be run. A tester may choose the test configurations to be run in a variety of different ways. In one implementation, a graphical user interface on computing device 104 allows a user to choose the types of tests that are to be run. For example, a tester may select which types of peripherals are to be tested, which combinations of peripheral devices are to be tested, which number of hubs will be placed between the peripherals and the computing device 104, etc. In another implementation, the test software could load a test file that includes data about which test configurations are to be run. The software may be extensible to enable a user to add new test parameters. Software running on the computing device 104 may be able to detect the failure of a test, e.g., due to timeout or crash of the system. If computing device 104 crashes, information may be saved to a debug file prior to shutdown of the computing device so that the reason for the crash can be determined. Control device 110 may determine that the computing device has crashed based on the amount of time since the last communication with the computing device, or based on receiving a debug file from the computing device. Software running on a computing device may perform other functions relating to the testing. For example, in response to determining that a particular configuration is to be tested, the software may cause the computing device to enter a particular test state, e.g., a particular power consumption mode. Software running on the computing device may perform functions of evaluating the performance of the computing device and/or the peripheral device in response to a test. It should be appreciated that any of the functions described above could be performed by software and/or firmware running on a different device, e.g., control device 1 10, instead of or in addition to software running on computing device 104.

Test software running on control device 110 may arbitrate the test in response to receiving requests from a computing device 104. For example, computing device 104 may request control device 110 to connect both mouse 108 and keyboard 106 to computing device 104. Once control device 110 receives this request, software on control device 110 may review the request and determine whether to make the requested connection. If a request is made for a connection to a device that is not connected to a switching device, control device may send a message to computing device 104 indicating to a tester that the requested device should be connected to a switching device. Control device 110 may keep a list of which peripheral devices are available, and which devices are unavailable, e.g., because they are being tested with a different computing device. Control device 110 may maintain a queue of requested test cases, and may execute the test cases based on which devices are available, the order in which the requests were received, the priority of the test requests, or any other suitable criteria. In some implementations, override of the queue may be allowed for a high priority test that needs to be run. When control device 110 determines that one or more test cases are to be run, control device 110 may send commands to one or more switching devices to make the requested connections.

In one aspect of the invention, information about a peripheral device may be gathered prior to running a test. For example, a new peripheral device may be profiled by software running on a computing device or a peripheral device. The profiling may be performed automatically, or in response to user input. Any suitable parameters about the peripheral device may be determined. For example, various parameters that may be determined include hardware ID, device speed, transfer type, transfer direction, transfer packet size, power requirements, remote wake capability, selective suspend capability, interface association descriptor support, MS OS descriptor support, isochronous transfer type, USB hub chipset, 1394 repeater chipset, etc. The information about the peripheral device may be saved by a computing device and/or a control device. Such information may be useful in a variety of circumstances. In one example, a customer may report a problem that a computer is experiencing when connected to a particular combination of peripheral devices. A tester may not have the exact same devices available for testing the troublesome configuration. However, the test system may have profiled peripheral devices that are similar to the devices used by the customer. The system may identify similar devices, and run a test configuration similar to the customer's configuration to re-produce the problem. Reproducing the problematic configuration using peripheral devices with similar profiles may facilitate determining the cause of the problem.

In some embodiments, a user-interface may be presented to illustrate to a user the progress of the testing. The user-interface could visually present to a user a representation of the test setup, showing connections that are currently made between computing devices and peripheral devices. Presenting a user-interface may enable a person to visualize the state of the testing. Any suitable visual presentation may be made, for example, by a monitor associated with a computing device and/or control device 110.

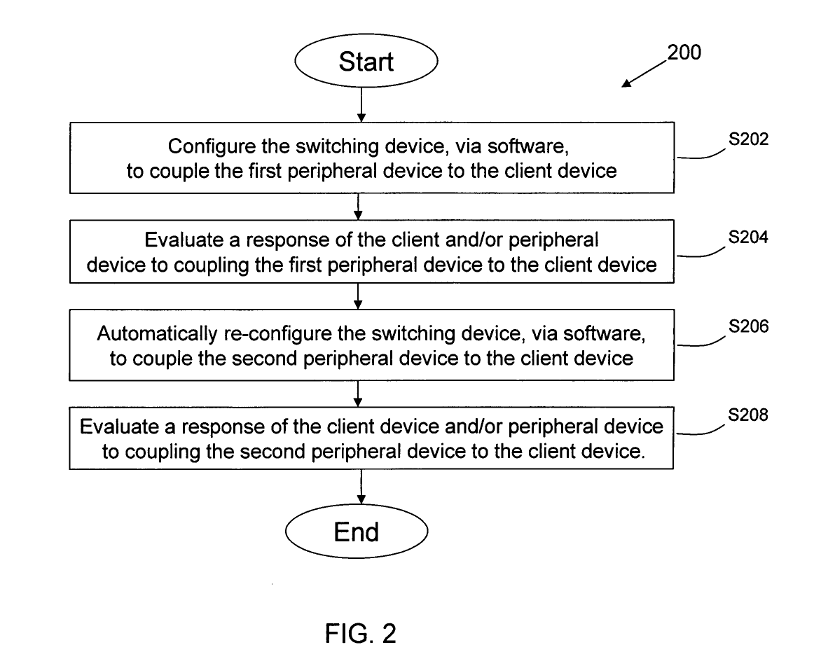

FIG. 2 is a flowchart illustrating an example of a method 200 of evaluating a computing device and/or a peripheral device, according to some embodiments of the invention. Method 200 may be performed by software and/or firmware running on a computing device 104, control device 110 and/or any other suitable device(s).

Computing device 104 may be tested with a first peripheral device, e.g., keyboard 106. To test the devices, the computing device 104 and the peripheral devices are coupled, e.g., via a wired connection. In step S202, the switching device may 102 be configured, via software and/or firmware, to couple the first peripheral device to the computing device via switching device 102. For example, switching device 102 may be configured by commands from control device 110 to couple keyboard 106 to computing device 104. Test software running on control device 210, or any other suitable device, may control sending the commands to switching device 102, e.g., in accordance with a programmed testing schedule. To couple the peripheral device and the computing device 104, one or more switches of switching device 102 may be turned on to provide a conductive path between the peripheral device and computing device 104 via switching device 102.

In step S204, a response of the computing device 104 may be evaluated, in response to coupling the first peripheral device to the computing device 104. For example, software running on computing device 104 may assess the ability of computing device 104 and keyboard 106 to communicate via wired bus 112. Any suitable type of evaluation may be made, e.g., using any suitable type of test. For example, software running on computing device 104, or any other suitable device, may record the actions taken by the operating system on computing device 104 when switching device 102 establishes a connection between computing device 104 and keyboard 106. As another example, the ability of computing device 104 to recognize keyboard 106 may be evaluated. Keyboard 106 may be capable of plug-and-play operation, and the ability of computing device 104 to support plug-and-play operation with keyboard 106 may be evaluated. As a further example, multiple different kinds of tests could be run. A test matrix of test data may be recorded based on the performance of computing device 104 and/or keyboard 106 during the testing. The computing device, the peripheral device, e.g., keyboard 106, or both devices may be evaluated in step S204.

Computing device 104 may be tested with a second peripheral device, e.g., mouse 108. To test the devices, the computing device 104 and the second peripheral device are coupled, e.g., via a wired connection. In step S206, switching device 102 may be automatically re-configured, via software and/or firmware, to couple the second peripheral device to the computing device 104. Step S206 may be performed automatically by control device 110 and/or switching device 102 without human intervention, e.g., without unplugging keyboard 106 or plugging in mouse 108. For example, switching device 102 may be automatically re-configured in response to receiving control commands sent from control device 110. Test software running on control device 210, or any other suitable device, may control sending the commands to switching device 102. The first peripheral device, e.g., keyboard 106, may be decoupled from computing device 104, prior to connecting a different peripheral device, and the second peripheral device, e.g., mouse 108, may be coupled to the computing device 104. However, the first peripheral device need not be decoupled from computing device 104 prior to coupling the second peripheral device to computing device 104. For example, both the first and second peripherals could be coupled to computing device 104 at the same time, e.g., via different ports of computing device 104.

In some embodiments, switching device 102 may be controlled to connect all the conductors associated with a wired bus at the same time. However, in some embodiments, some of the conductors may be connected prior to other conductors. For example, switching device 102 may connect the power conductors of a connection, e.g., a USB connection, prior to connecting the data pins for the connection. Connecting the power pins first may ensure that the peripheral device receives power prior to any exchange of data via the connection.

In step S208, a response of the computing device to coupling the second peripheral device to the computing device may be evaluated. For example, software running on computing device 104 may assess the ability of computing device 104 and mouse 108 to communicate via wired bus 112. Any suitable type of evaluation may be made, e.g., using any suitable type of test. For example, software running on computing device 104, or any other suitable device, may record the actions taken by the operating system on computing device 104 when switching device 102 establishes a connection between computing device 104 and mouse 108. As another example, the ability of computing device 104 to recognize mouse 108 may be evaluated. Mouse 108 may be capable of plug-and-play operation, and the ability of computing device 104 to support plug-and-play operation with mouse 108 may be evaluated. As a further example, multiple different kinds of tests could be run. A test matrix of test data may be recorded based on the performance of computing device 104 and/or mouse 108 during the testing. The computing device, the peripheral device, e.g., mouse 108, or both devices may be evaluated in step S208.

In another embodiment, a peripheral device may be tested while coupled to different ports of computing device 104. As one example, a peripheral may first be coupled to a first port of computing device 104, and the response of the computing device and/or the peripheral device communicating via the first port may be evaluated. Switching device 102 may be automatically re-configured to couple the peripheral to a second port of computing device 104, and the response of the computing device and/or the peripheral device communicating via the second port may be evaluated. Testing the peripheral device with more than one port of computing device 104 may enable evaluating the ability of computing device 104 to function with the peripheral through different ports. If more than one port of computing device 104 is to be coupled to switching device 102, a separate wired bus 112 may be connected to each port of computing device 104 that is to be used.

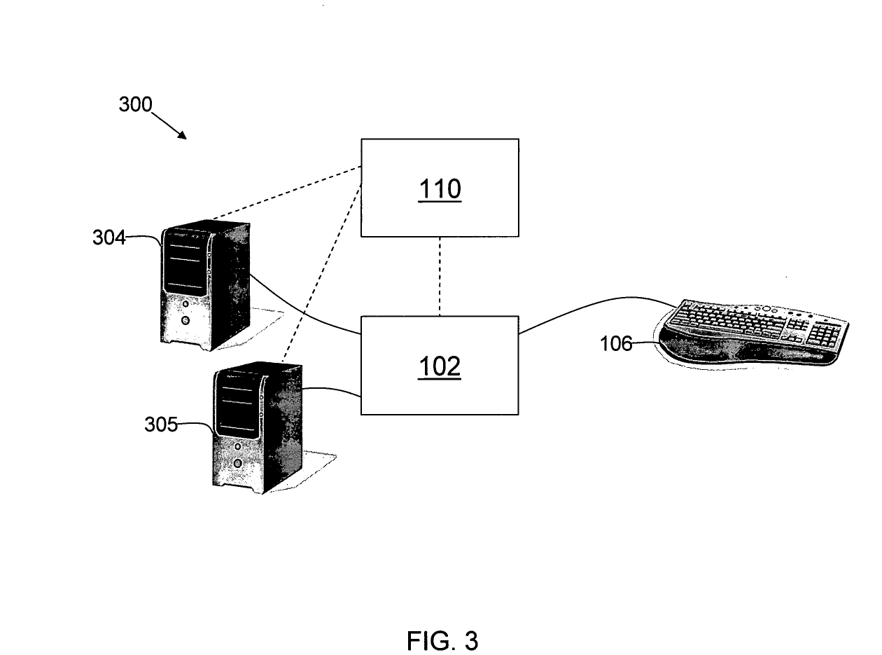

FIG. 3 illustrates an example of a computing environment in which embodiments of the invention may be implemented, including two computing devices 304 and 305 and one peripheral device, e.g., keyboard 106. As discussed above, some embodiments of the invention enable testing a peripheral device with more than one computing device. It may be desirable to test the peripheral device with different types of computing devices, e.g., different types of computers. For example, computing devices 304 and 305 may have different operating systems, processor speeds, machine configurations, chipsets or any other suitable characteristics different between computing devices 304 and 305. The computing devices 304 and 305 and/or the peripheral device may be evaluated as to their ability to communicate via a wired bus.

In one implementation, switching device 102 may be configured to couple keyboard 108 to computing device 304. The response of computing device 304 and/or keyboard 108 may be evaluated. Switching device 102 may be automatically reconfigured, via software and/or firmware, to decouple keyboard 108 from computing device 304, and to couple keyboard 108 to computing device 305. The response of computing device 305 and/or keyboard 108 may be evaluated. Any suitable type of evaluation may be performed, including the types of evaluation described above or any other suitable type of evaluation.

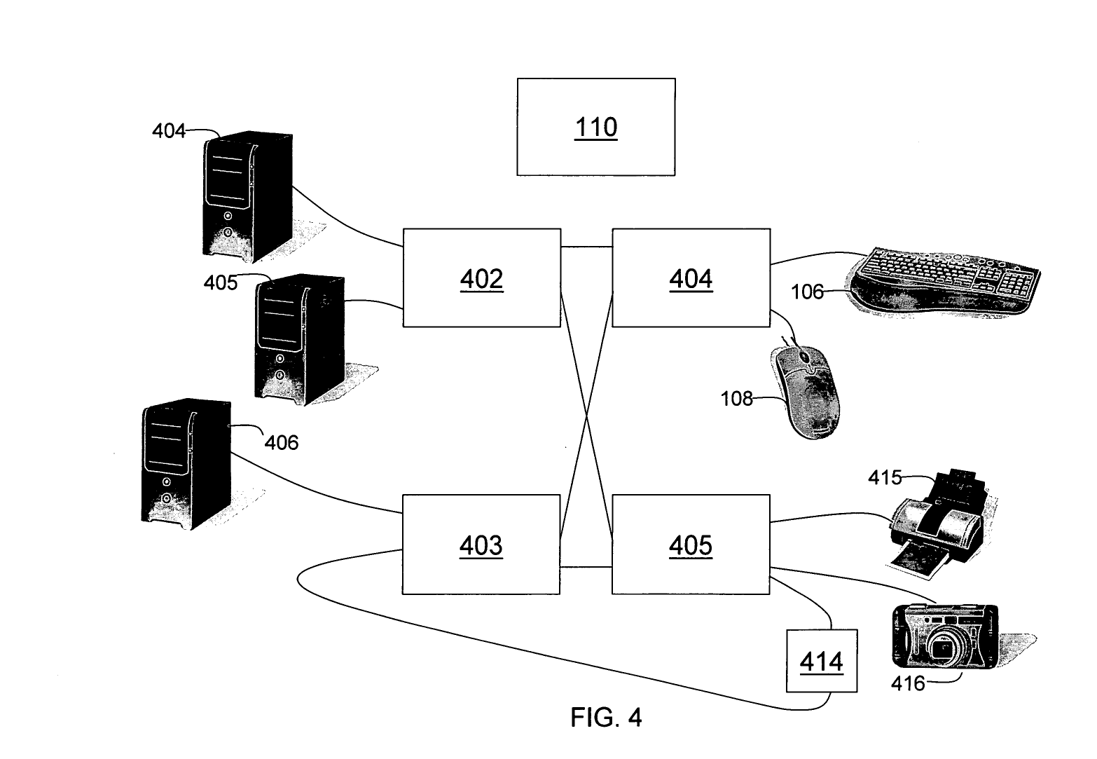

FIG. 4 illustrates an example of a computing environment in which embodiments of the invention may be implemented, including multiple computing devices and multiple peripheral devices, including keyboard 106, mouse 108, hub 414, printer 415 and digital camera 416. Computing devices 404-406 may be any suitable computing devices, such as any of the types of computing devices discussed above. In accordance with this embodiment, multiple peripheral devices may be tested with multiple computing devices.

In this embodiment, multiple switching devices, including at least two of switching devices 402-405, may be used to couple a peripheral device to a computing device. Multiple switching devices may be used because a single switching device may be limited as to the number of connections it can support because of electromagnetic interference considerations. Using multiple levels of switching devices may enable testing a large number of computing devices with a large number of peripheral devices. A first level may include switching devices 402 and 403, and a second level may include switching devices 404 and 405. In one example, computing device 404 may be coupled to digital camera 416 via switching devices 402 and 405. Any of the computing devices 404-406 may be coupled to any of the peripheral devices through a suitable combination of switching devices 402-405. Control device 110 or any other suitable device may control switching devices 402-405 via any suitable control connection, although this control connection has not been illustrated in FIG. 4 for clarity.

Control device 110 may control the testing of computing devices and/or peripheral devices in any suitable way. In some embodiments, the testing may be performed at least partially through software running on a computing device. For example, software running on a computing device may control the test, and commands may be sent to the switching device via control device 110, which may be a server configured to communicate with one or more computing devices. In some embodiments, test may be controlled in an intelligent manner based on the availability of computing devices and/or peripheral devices. As discussed above, software may determine the availability of devices, e.g., whether or not a device is currently being tested, and then determine which tests can be run to maximize the usage of the available connections and devices, and thus reduce the time required to complete all of the tests.

Control device 110 may control the testing when one or more peripheral devices are connected to a computing device through one or more hubs, e.g., hub 414. Hub 414 may be a single or multi-TT USB hub, for example. As one example, computing device 406 may be tested with keyboard 106, however, keyboard 106 may be coupled to computing device 406 via hub 414. A connection route may proceed from computing device 406 through switching device 403, switching device 405, hub 414, switching device 403, and switching device 404 to keyboard 106, for example. It should be appreciated that any suitable connection topologies can be tested. For example, multiple layers of hubs may be used, and multiple devices may be connected to each of the hubs. Embodiments of the invention enabling scaling the number and configuration of switching devices and peripheral devices to the test configurations that are desired to be run.

Four test scenarios will now be described as examples of tests that embodiments of the invention may be capable of performing. These test scenarios are described merely by way of illustration, as the invention is not limited as to any particular type of testing. As described below client software may be the software running on a computing device, and the server software may be the software running on a control device.

1) Unplug/plug of device while computing device is in a low power state.
a. Client software tells the server software to connect or disconnect a particular peripheral device (or series of devices) at a certain time
b. The client software causes the computing device to enter a low power state for a certain period of time
c. While the computing device is in a low power state, the control device 110 performs the action specified in step a by controlling switching device 102.

2) Connect a tree of devices to a single TT USB hub, and connect that hub to a particular USB host controller
a. The control software running on control device 110 determines which of the hubs in the matrix are single-TT hubs
b. The server software determines which of the computing devices in the test matrix use the particular USB host controller
c. The control device software has a list of test cases that need to be performed for each configuration
d. Client software communicates with control device 110, looking at the list of test cases and looks for test cases that it is capable of performing
e. Once the client software finds a case it can run, it puts in a request to the control device to connect that hub to the test machine the client software is running on.
f. The server software receives that request and processes it
   i. If a single TT hub is available immediately, the control device software connects that hub to the test machine
   ii. If all single TT hubs are currently in use, the control device software reports back to the client the time at which the device should be available.
      1. The client software can then choose to wait for a particular single-TT hub to become available, wait for any single-TT hub to become available or skip the test case and return to it at a later time.
   iii. If all of the requested devices are available immediately, the control device software connects those devices to the hub
   iv. If some or all of the devices are currently in use, the control device software reports back to the client the ETA on when those devices should be free again.
   v. The client software can then choose to wait for a particular device to become available, wait for any of that class of device to become available or skip the test case and return to it at a later time

3) Connect multiple levels of multi-TT USB hubs, with a mix of devices at each level of hub depth
a. The control device software determines which of the hubs in the matrix are single-TT hubs
b. The control device software determines which of the computing devices in the matrix use the particular USB host controller
c. The control device software determines what mix of devices are available to the computing devices connected to this hardware switcher
d. The control device software has a list of test cases that need to be performed for each configuration
e. Client software communicates with control device machine, looking at the list of test cases and looks for test cases that it is capable of performing
f. Once the client software finds a case it can run, it puts in a request to the control device to connect that hub to the client machine
g. The control device software receives that request and processes it
   i. If a multi-TT hub is available immediately, the control device software connects that hub to the test machine
   ii. If all multi-TT hubs are currently in use, the control device software reports back to the client the time on at which the peripheral device should be available.
      1. The client software can then choose to wait for a particular multi-TT hub to become available, wait for any multi-TT hub to become available or skip the test case and return to it at a later time.
   iii. If all of the requested devices are available immediately, the control device software connects those devices to the hubs in the tree in a manner that is described by the test case
   iv. If some or all of the devices are currently in use, the control device software reports back to the client the time at which those devices should be free again.
   v. The client software can then choose to wait for a particular peripheral device to become available, wait for any of that class of device to become available or skip the test case and return to it at a later time

4) Connect a device through as many 1394 repeaters as possible and validate that it still functions
a. The control device software determines which of the connections is associated with a 1394 repeater, and knows the minimum number of repeaters needed to run this test case
b. The control device software determines which of the connections is associated with the particular 1394 device
c. The control device software determines which of the PCs in the matrix use the particular 1394 host controller
d. The control device software has a list of test cases that need to be performed for each configuration
e. Client software communicates with control device, looking at the list of test cases and looks for test cases that it is capable of performing
f. Once the client software finds a case it can run, it puts in a request to the control device to connect that repeater to the test machine the client software is running on
g. The control device software receives that request and processes it
   i. If enough repeaters are available immediately, the control device software connects those repeaters to each other, then the test machine
   ii. If there are not enough repeaters available, the control device software reports back to the client the ETA on when enough repeaters should be available.
      1. The client software can then choose to wait for a particular repeater to become available, wait for any other repeaters to become available or skip the test case and return to it at a later time.
   iii. If the 1394 device to be tested is available immediately, the control device software connects that device to the repeaters
   iv. If the 1394 device is currently in use, the control device software reports back to the client the time at which the device should be available.
      1. The client software can then choose to wait for a particular device to become available, wait for any other devices of the same type to become available or skip the test case and return to it at a later time.

Particular implementation details of computer systems that may execute aspects of the invention will now be described. These implementation details are provided by way of example only, and the invention is not limited to any particular implementation.

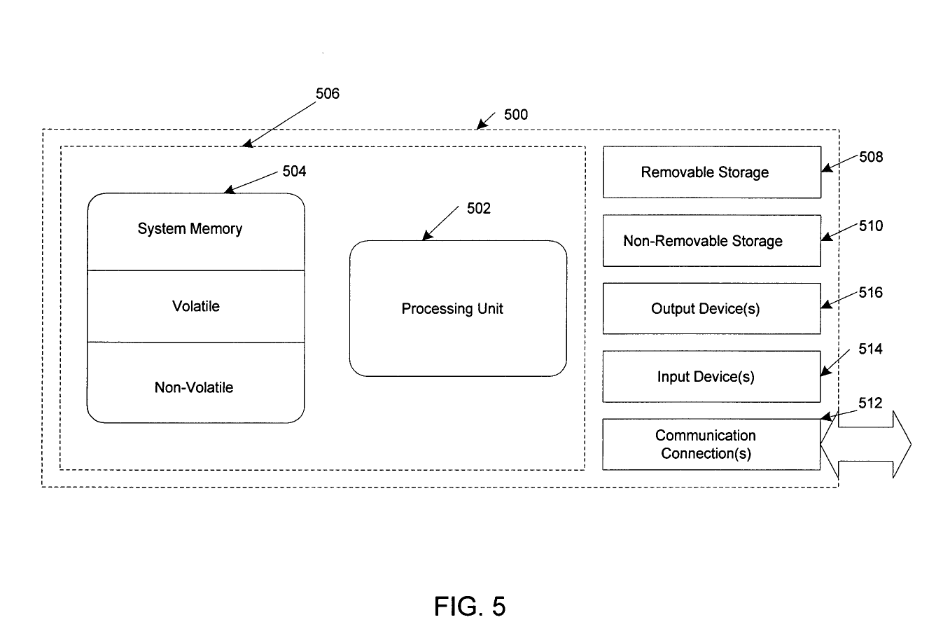

With reference to FIG. 5, an exemplary system for implementing embodiments of the invention includes a computing device, such as computing device 500, which may be a device suitable to function as a computing device 104 or control device 110. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 5 by dashed line 506. Additionally, device 500 may also have additional features/functionality.

Device 500 may include at least some form of computer readable media. Computer readable media can be any available media that can be accessed by device 500. By way of example, and not limitation, computer readable media may comprise computer storage media and communication media. For example, device 500 may also include additional storage (removable and/or non-removable) including, but not limited to, magnetic or optical disks or tape. Such additional storage is illustrated in FIG. 5 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Device 500 may also contain communications connection(s) 512 that allow the device to communicate with other devices. Communications connection(s) 512 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 500 may also have input device(s) 514 such as keyboard, mouse, pen, voice input device, touch input device, etc. Output device(s) 516 such as a display, speakers, printer, etc. may also be included. All these devices are well know in the art and need not be discussed at length here.

It should be appreciated that the invention is not limited to executing on any particular system or group of systems. For example, embodiments of the invention may run on one device or on a combination of devices. Also, it should be appreciated that the invention is not limited to any particular architecture, network, or communication protocol.

Having now described some embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. The foregoing description and drawings are by way of example only. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. The use of “including,” “comprising,” or “having,” “containing,” “involving,” and variations thereof herein, is meant to encompass the items listed thereafter and equivalents thereof as well as additional items.

What is claimed is:

1. A method of evaluating a computing device, the computing device being coupled to a switching device, the switching device being coupled to a first peripheral device and a second peripheral device, the method comprising:
configuring the switching device to couple the first peripheral device to the computing device via the switching device;
evaluating a response of the computing device to coupling the first peripheral device to the computing device;
automatically re-configuring the switching device to couple the second peripheral device to the computing device via the switching device; and
evaluating a response of the computing device to coupling the second peripheral device to the computing device.

2. The method of claim 1, wherein automatically re-configuring the switching device comprises re-configuring the switching device in response to a command received from a control device, the control device having sent the command based on a test parameter determined by test software.

3. The method of claim 1, wherein automatically re-configuring the switching device comprises decoupling the first peripheral device from the computing device prior to coupling the computing device to the second peripheral device.

4. The method of claim 1, wherein configuring the switching device comprises coupling the first peripheral device to a first port of the computing device, and evaluating a response of the computing device to coupling the first peripheral device comprises evaluating a response of the computing device to coupling the first peripheral device to the first port, and further comprising:
automatically re-configuring the switching device to couple the first peripheral device to a second port of the computing device; and
evaluating a response of the computing device to coupling the first peripheral device to the second port of the computing device.

5. The method of claim 1, wherein automatically re-configuring the switching device comprises re-configuring the switching device without human intervention.

6. The method of claim 1, wherein evaluating the response of the computing device comprises evaluating a response of an operating system associated with the computing device.

7. The method of claim 1, further comprising:
controlling the computing device to enter a first test state for testing the computing device with the first peripheral device.

8. The method of claim 1, wherein the switching device comprises a plurality of switching devices arranged in at least two levels of switching devices.

9. The method of claim 1, wherein the switching device is coupled to the first peripheral device, the second peripheral device and the computing device via a universal serial bus connection.

10. At least one computer-readable medium having computer-executable instructions encoded thereon that, when executed, perform acts of a method of evaluating a computing device, the computing device being coupled to a switching device, the switching device being coupled to a first peripheral device and a second peripheral device, the method comprising:
configuring the switching device to couple the first peripheral device to the computing device via the switching device;
evaluating a response of the computing device to coupling the first peripheral device to the computing device;
automatically re-configuring the switching device to couple the second peripheral device to the computing device via the switching device, the switching device being automatically re-configured in response to receiving a test command; and
evaluating a response of the computing device to coupling the second peripheral device to the computing device.

11. The computer-readable medium of claim 10, wherein automatically re-configuring the switching device comprises re-configuring the switching device in response to a command received from a control device, the control device having sent the command based on a test parameter determined by test software.

12. The computer-readable medium of claim 10, wherein automatically re-configuring the switching device comprises decoupling the first peripheral device from the computing device prior to coupling the computing device to the second peripheral device.

13. The computer-readable medium of claim 10, wherein configuring the switching device comprises coupling the first peripheral device to a first port of the computing device, and evaluating a response of the computing device to coupling the first peripheral device comprises evaluating a response of the computing device to coupling the first peripheral device to the first port, and further comprising:
automatically re-configuring the switching device to couple the first peripheral device to a second port of the computing device; and
evaluating a response of the computing device to coupling the first peripheral device to the second port of the computing device.

14. The computer-readable medium of claim 10, wherein automatically re-configuring the switching device comprises re-configuring the switching device without human intervention.

15. The computer-readable medium of claim 10, wherein evaluating the response of the computing device comprises evaluating a response of an operating system associated with the computing device.

16. The computer-readable medium of claim 10, further comprising:
controlling the computing device to enter a first test state for testing the computing device with the first peripheral device.

17. The computer-readable medium of claim 10, wherein the switching device comprises a plurality of switching devices arranged in at least two levels of switching devices.

18. The computer-readable medium of claim 10, wherein the switching device is coupled to the first peripheral device, the second peripheral device and the computing device via a universal serial bus connection.

19. A system for evaluating at least one peripheral device, the system comprising:
a computing device coupled to a switching device, the switching device being coupled to a first peripheral device and a second peripheral device;
wherein the system is configured to;
couple the first peripheral device to the computing device via the switching device;
evaluate a response of the first peripheral device to coupling the first peripheral device to the computing device;
automatically re-configure the switching device to couple the second peripheral device to the computing device via the switching device; and
evaluate a response of the second peripheral device to coupling the second peripheral device to the computing device.

20. The system of claim 19, wherein automatically re-configuring the switching device comprises re-configuring the switching device in response to a command received from a control device, the control device having sent the command based on a test parameter determined by test software.
